(19) United States
(12) Patent Application Publication
(10) Pub. No.: US 2005/0228655 A1
(43) Pub. Date: Oct. 13, 2005

(54) Real-time objective voice analyzer

(75) Inventors: Binshi Cao, Bridgewater, NJ (US); Doh-Suk Kim, Basking Ridge, NJ (US); Ahmed A. Tarraf, Bayonne, NJ (US)

Correspondence Address: Mark W. Sincell;Williams, Morgan & Amerson, P.C., 10333 Richmond, Suite 1100, Houston, TX, 77042, US

(73) Assignee: Lucent Technologies, Inc.

(21) Appl. No.: 10/818,435

(22) Filed: Apr. 5, 2004

(51) Int. Cl. G10L 19/10

(52) U.S. Cl. 704/220

(57) ABSTRACT

The present invention provides a method and an apparatus for real time objective voice analysis. The apparatus includes a sound quality analyzer for receiving at least one first signal and providing at least one second signal indicative of at least one non-intrusive estimate of a sound quality based on the at least one first signal.

### BACKGROUND OF THE INVENTION

1. Field of the Invention

This invention relates generally to network systems, and, more particularly, to speech signals in network systems.

2. Description of the Related Art

Speech signals may be transmitted by a variety of network systems, including plain old telephone systems (POTS), Internet-based networks that utilize voice-over-Internet protocols (VoIP), wireless telecommunication systems, and the like. A source speech signal, e.g. an acoustic signal produced by a first user's voice, is typically processed by many devices as it travels through a network system to a second user's ear. For example, in a wireless telecommunications network, the source speech signal may be processed by a first mobile unit, a first base station, a network hub, a second base station, a second mobile, and other intermediate devices before the second user hears the processed speech signal.

Each device in the network system, as well as the wired and/or wireless channels that transmit the processed speech signal, may modify the processed speech signal. Some of these modifications may be desirable. For example, various filters may be used to remove unwanted noise from the processed speech signal, comfort noise may be added to the processed speech signal to remove un-natural sounding silences, and the processed speech signal may be compressed to reduce the total amount of data that is transmitted. Other modifications to the processed speech signal may not be desirable. For example, transmission errors may be introduced into the processed speech signal as it travels through the network. These errors may result in gaps in the processed speech signal, unwanted noise, and the like.

Processing of the source speech signal by the network system, whether desirable or undesirable, may result in some degradation in the quality of the processed speech signal. Subjective techniques based upon human perception may be used to evaluate the quality of the processed speech signals. For example, a database of source speech samples may be processed by a network system and the processed speech signals may be provided to a team of listeners, who rate the processed speech signals on a scale of 1 to 5. However, subjective techniques are time-consuming and expensive. Examples of the costly and/or time-consuming aspects of subjective testing include assembling the speech database, recruiting and paying a large listening team to provide a statistically significant estimate of the speech quality, and providing a sound-proof room and other equipment.

Objective methods may also be used to evaluate the quality of the processed speech signals. In a typical objective evaluation of the processed speech quality, usually referred to as an intrusive method, a source speech signal is processed by the network system and then both the source speech sample and the processed speech sample are provided to a computer. The computer then compares the source and processed speech signals to estimate the quality of the processed speech signal. However, if the source speech signal is not available, the conventional intrusive objective methods cannot be used to estimate the quality of the processed speech signal. An estimated source speech signal may be substituted for the missing source speech signal, but the quality of the estimated source speech signal degrades as the distortion of the processed speech signal increases.

The present invention is directed to addressing the effects of one or more of the problems set forth above.

### SUMMARY OF THE INVENTION

In one embodiment of the instant invention, an apparatus is provided for real time objective voice analysis. The apparatus includes a sound quality analyzer for receiving at least one first signal and providing at least one second signal indicative of at least one non-intrusive estimate of a sound quality based on the at least one first signal.

In another embodiment of the present invention, a method is provided for real time objective voice analysis. The method includes receiving at least one first signal indicative of at least one processed speech signal, determining, non-intrusively, a sound quality of the at least one processed speech signal based on the at least one first signal, and providing at least one second signal indicative of the sound quality of the at least one processed speech signal.

### BRIEF DESCRIPTION OF THE DRAWINGS

The invention may be understood by reference to the following description taken in conjunction with the accompanying drawings, in which like reference numerals identify like elements, and in which:

FIG. 1 shows a telecommunication network including a sound quality analyzer, in accordance with one embodiment of the present invention;

FIG. 2 shows one exemplary embodiment of a sound quality analyzer such as the sound quality analyzer shown in FIG. 1, in accordance with one embodiment of the present invention;

FIG. 3A shows one exemplary embodiment of a graphical user interface that may be used to display information provided by the sound quality analyzer shown in FIG. 2, in accordance with one embodiment of the present invention; and

FIG. 3B shows an exemplary portion of a waveform of a processed speech signal that may be viewed using the graphical user interface shown in FIG. 3A, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

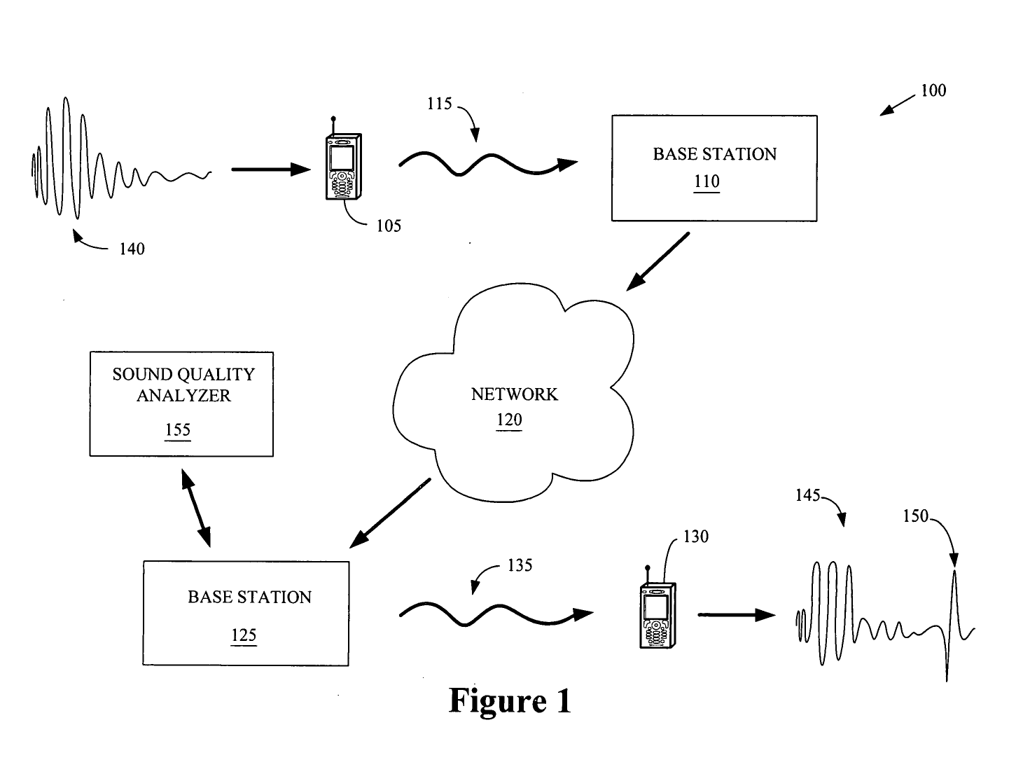

FIG. 1 shows an exemplary embodiment of a wireless telecommunication network 100. Although the present invention will be described in the context of the exemplary embodiment of the wireless telecommunications network 100, persons of ordinary skill in the art should appreciate that the present invention is not limited to wireless telecommunications networks such as that shown in FIG. 1. In alternative embodiments, the present invention may be practiced in other networks including plain old telephone systems (POTS), Internet-based networks that utilize voice-over-Internet protocols (VoIP), and the like. Moreover, the structure and operation of the wireless telecommunication network 100 are generally known to persons of ordinary skill in the art and so, in the interest of clarity, only those aspects of the structure and operation of the wireless telecommunication network 100 that are useful for an understanding of the present invention will be described herein.

The wireless telecommunication network 100 includes a first mobile unit 105 that may transmit signals to, and receive signals from, a base station 110 via a wireless communication channel 115. The base station 110 is communicatively coupled to a network 120. In various alternative embodiments, the base station 110 may be communicatively coupled to the network 120 in any desirable manner including wireless communication links, wired communication links, and the like. The network 120 may include devices such as routers, switches, filters, signal processors, and the like, which may be interconnected in any desirable manner. The network 120 is also communicatively coupled to at least one base station 125, which may provide and/or receive signals from a mobile unit 130 via a wireless communication channel 135.

In operation, a source speech signal 140 is provided to the mobile unit 105. For example, a first user may speak into the microphone (not shown) included in the mobile unit 105. The mobile unit 105 processes the source speech signal 140 to form a processed speech signal 145, which is transmitted to the base station 110. From the base station 110, the processed speech signal 145 may be transmitted to the mobile unit 130 via the network 120, the base station 125, the wireless communication channel 135, and other intermediate devices and/or channels. The mobile unit 130 may then provide an acoustic signal to a second user based upon the processed speech signal 145.

The processed speech signal 145 may be modified by the mobile units 105, 130, the base stations 110, 125, the network 120, the wireless communication channels 115, 135, and other intermediate devices and/or channels. Consequently, the processed speech signal 145 may differ from the source speech signal 140. Generally speaking, the modifications to the source speech signal 140 tend to degrade the sound quality of the processed speech signal 145. For example, the processed speech signal 145 may include a noise spike 150 that is not present in the source speech signal 140. However, relatively small degradations in the sound quality of the processed speech signal 145 may not be readily perceptible to the human ear and thus may not be cause for concern.

Accordingly, a sound quality analyzer 155 is provided to estimate the sound quality of the processed speech signal 145 using a non-intrusive sound quality estimation technique. In accordance with common usage in the art, the term “non-intrusive” will be understood herein to refer to sound quality estimation techniques that may be performed without using the original source speech signal. In the embodiment shown in FIG. 1, the sound quality analyzer 155 may receive a signal indicative of the processed speech signal 145 from the base station 125 and estimate the sound quality of the processed speech signal 145 based upon the received signal. However, at least in part because the sound quality analyzer 155 uses the non-intrusive sound quality estimation technique, the sound quality analyzer 155 may receive the signal indicative of the processed speech signal 145 from any portion of the wireless communication network 100. For example, in one embodiment, the sound quality analyzer 155 may receive the signal indicative of the processed speech signal 145 from a portion of the network 120.

In the exemplary embodiment shown in FIG. 1, the sound quality analyzer 155 is outside of the path of the processed speech signal 145. However, the present invention is not limited to sound quality analyzers 155 that are outside of the path of the processed speech signal 145. In alternative embodiments, the sound quality analyzer 155 may be deployed substantially within the path of the processed speech signal 145. For example, sound quality analyzer 155 may be deployed in series between the base station 125 and the mobile unit 130. In other alternative embodiments, the sound quality analyzer 155 may be deployed in parallel with any portion of the wireless communication network 100. Furthermore, more than one sound quality analyzer 155 may be deployed to estimate the sound quality of the processed speech signal 145 at selected points in the wireless telecommunications network 100 using non-intrusive techniques.

In one embodiment, the sound quality analyzer 155 may provide feedback to the base station 125 based upon the non-intrusively estimated sound quality of the processed speech signal 145. For example, the sound quality analyzer 155 may determine that the sound quality of the processed speech signal 145 has been degraded by the presence of the noise spike 150 and may provide a signal to the base station 125 indicating that it may be desirable to apply a filtering process to attempt to reduce the amplitude of the noise spike 150 in the processed speech signal 145. However, persons of ordinary skill in the art should appreciate that the present invention is not limited to applying filtering processes and, in alternative embodiments, any desirable signal processing technique may be used by any desirable device to reduce the effects of undesirable portions of the processed speech signal 145 in response to feedback provided by the sound quality analyzer 155.

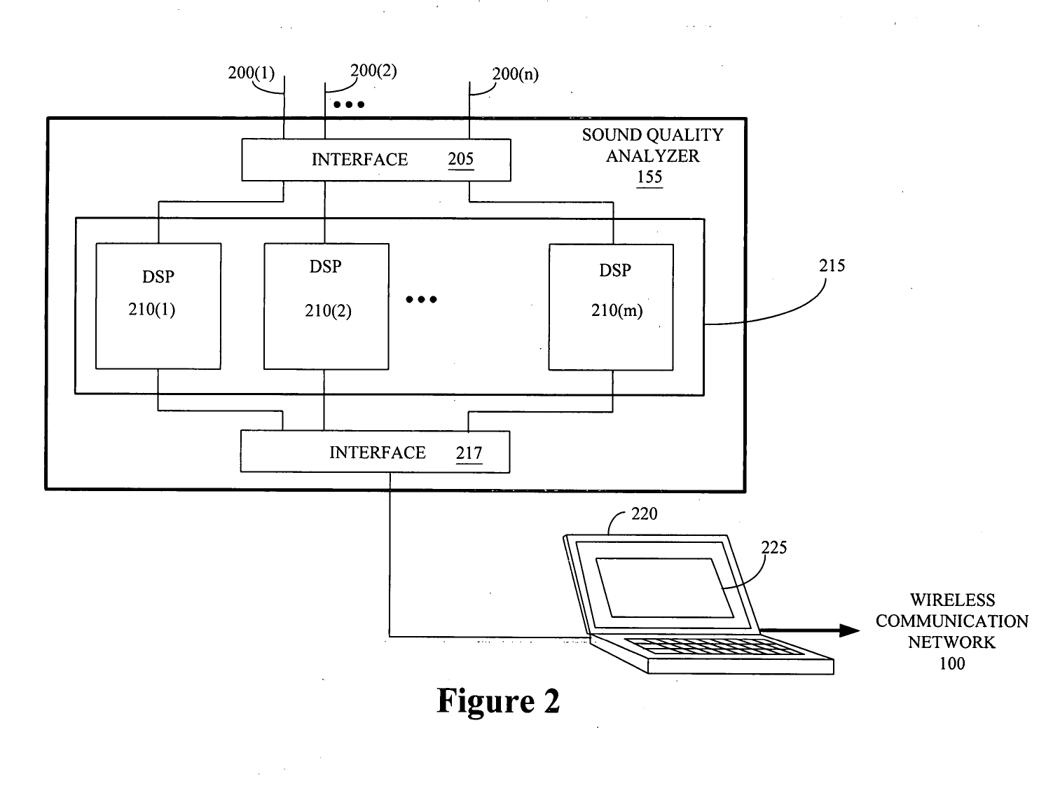

FIG. 2 shows an exemplary embodiment of the sound quality analyzer 155. The sound quality analyzer 155 may receive one or more processed speech signals, such as the processed speech signal 145 shown in FIG. 1, via one or more input lines 200(1-n). In one embodiment, the input lines 200(1-n) are T1 lines, which can be obtained from converters connected to a gateway device (not shown), such as an OC3-T1 converter that is coupled to a Cisco Media Gateway MGX. A single T1 line typically carries about 24 call channels. However, persons of ordinary skill in the art should appreciate that the input lines 200(1-n) are not restricted to being T1 lines and, in alternative embodiments, may be any desirable type of lines carrying any desirable number of call channels.

The input lines 200(1-n) provide the processed speech signals to an interface 205, such as a PCMCIA interface and the like. The interface 205 may provide one or more signals indicative of the processed speech signals to one or more digital signal processors (DSPs) 210(1-m). In the illustrated embodiment, the digital signal processors 210 are formed on individual chips that are deployed on a board 215. However, the present invention is not limited to one or more digital signal processors 210(1-m) deployed on a single board 215. In alternative embodiments, the board 215 may not be provided. In other alternative embodiments, the digital signal processors 210(1-m) may be deployed on a plurality of boards 215.

The digital signal processors 210(1-m) implement a non-intrusive method of estimating a sound quality of the processed speech signal 145. In one embodiment, the digital signal processors 210(1-m) implement an Auditory Non-Intrusive Quality Estimation (ANIQUE) algorithm. This auditory-articulatory analysis technique utilizes a comparison between a power in an articulation frequency range and a power in a non-articulation frequency range to estimate the sound quality of a speech signal. For example, the ANIQUE algorithm may estimate the sound quality of the processed speech signal by comparing the power in an articulation frequency range of about 2-12.5 Hz to the power in a non-articulation frequency range of greater than about 12.5 Hz. Exemplary embodiments of the non-intrusive ANIQUE algorithm may be found in Kim, “Auditory-Articulatory Analysis for Speech Quality Assessment,” U.S. patent application Ser. No. 10/186,840, filed on Jul. 1, 2002 and which is hereby incorporated in its entirety.

The complexity of the ANIQUE algorithm may be obtained by adopting a Weighted Million Operations Per Second calculation routine from a Selectable Mode Vocoder to the C source code used to implement the ANIQUE algorithm. The estimation results indicate that the ANIQUE algorithm has a complexity of approximately 217 weighted million operations per second. However, this estimate depends on the specific implementation of the algorithm, as should be appreciated by persons of ordinary skill in the art. For example, the estimate of the complexity of the ANIQUE algorithm may be reduced to approximately 122 weighted million operations per second or less by reducing the number of fast Fourier transform points from 4096 to 2048, using four simultaneous multiplication and accumulation operations during a filtering process, optimizing the source code, and the like

In one embodiment, the sound quality analyzer 155 includes 16 digital signal processors 210(1-m). If the non-intrusive sound quality estimation technique implemented in each of the digital signal processors 210(1-m) uses operating speeds of about 80 million instructions per second, which is somewhat less the 122 weighted million operations per second discussed above with regard to the ANIQUE algorithm, then this embodiment of the sound quality analyzer 155 may concurrently process approximately 64 call channels. However, persons of ordinary skill in the art should appreciate that this estimate of the number of call channels that may be concurrently processed by the sound quality analyzer 155 is intended to be exemplary and not intended to limit the present invention.

The digital signal processors 210(1-m) provide one or more signals indicative of the estimated sound quality of the processed speech signal to an interface 217, such as a PCMCIA interface and the like. In one embodiment, the interface 217 may provide one or more signals indicative of the estimated sound quality to a computer 220. For example, the interface 217 may provide a signal to a laptop computer 220. The computer 220 may then display information indicative of the estimated sound quality of the processed speech signals on one or more communication channels analyzed by the sound quality analyzer 155. For example, the computer 220 may display the information using a graphical user interface 225.

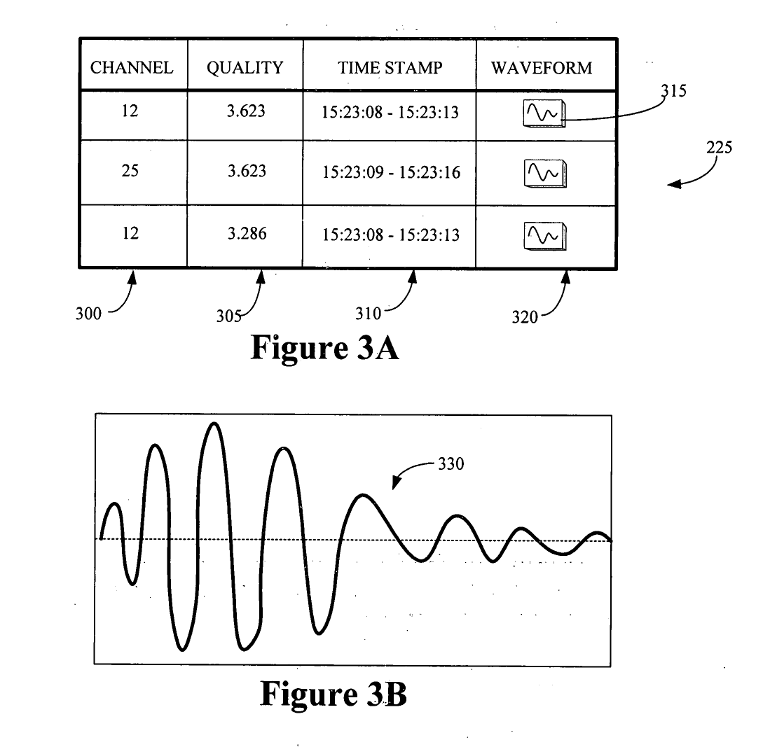

FIG. 3A shows one exemplary embodiment of the graphical user interface 225. In the illustrated embodiment, the graphical user interface 225 displays information indicative of a communication channel (such as a channel number) in column 300, information indicative of the estimated sound quality (such as a sound quality rating between 1 and 5) in column 305, information indicative of the time and/or duration of the processed speech signal (such as a time stamp) in column 310, and a user-activated button 315 in column 320 that may allow a user to view a portion of a waveform of the processed speech signal, such as the exemplary waveform 330 shown in FIG. 3B. However, persons of ordinary skill in the art will appreciate that the present invention is not limited to information shown in FIG. 3A and, in alternative embodiments, any desirable information may be displayed in the graphical user interface 225.

Referring back to FIG. 2, the sound quality analyzer 155 may provide feedback based upon the non-intrusive estimate of the sound quality, as discussed above. Accordingly, in one embodiment, the computer 220 is communicatively coupled to the wireless communication network 100 and may provide signals indicative of modifications that may be applied to the processed speech signal. The signals may be provided to one or more devices in the wireless communication network 100 and may be used by the devices to modify the processed speech signal. Alternatively, the computer 220 may modify the processed speech signal. For example, the computer 220 may allow a user to select and/or apply various sound editing tools to the processed speech signal. The sound editing tools may include time and/or frequency filtering, compressing, interpolating, fading, normalizing, enveloping, and the like.

Since the sound quality analyzer 155 described above may estimate the sound quality of one or more processed speech signals non-intrusively, i.e. without using a source speech signal, the sound quality analyzer 155 may be used to estimate sound quality of in-service networks and other systems where the source speech signal is not available. Furthermore, the sound quality analyzer 155 does not need to be driven with pre-determined test signals, and since the sound quality analyzer 155 objectively estimates the sound quality, the time and cost of estimating the sound quality of a network may be reduced relative to conventional subjective methods.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. An apparatus, comprising:
a sound quality analyzer for receiving at least one first signal and for providing at least one second signal indicative of at least one non-intrusive estimate of a sound quality based on the at least one first signal.

2. The apparatus of claim 1, wherein the at least one first signal comprises at least one processed speech signal.

3. The apparatus of claim 2, comprising a first interface for receiving the at least one processed speech signal and for providing the at least one first signal based on the at least one processed speech signal.

4. The apparatus of claim 3, comprising a second interface for receiving the at least one second signal and for providing at least one third signal based upon the at least one second signal.

5. The apparatus of claim 4, wherein the second interface is capable of providing the at least one third signal to a computer.

6. The apparatus of claim 5, wherein the computer is capable of displaying information indicative of the at least one non-intrusive estimate of the sound quality of the at least one first signal.

7. The apparatus of claim 6, wherein the computer is capable of displaying the information using a graphical user interface that is configured to display at least one of information indicative of a communication channel, information indicative of the estimated sound quality, information indicative of the time and/or duration of the processed speech signal, and a button that allows a user to view a portion of a waveform of the processed speech signal.

8. The apparatus of claim 5, wherein the computer is configured to determine at least one modification to the processed speech signal based on the estimated sound quality.

9. The apparatus of claim 1, wherein the sound quality analyzer comprises at least one digital signal processing circuit configured to receive the at least one first signal and provide at least one second signal indicative of at least one non-intrusive estimate of a sound quality of the at least one processed speech signal based on the at least one first signal.

10. The apparatus of claim 9, wherein the sound quality analyzer comprises a plurality of digital signal processing circuits configured to concurrently receive a plurality of first signals and estimate a plurality of sound qualities of a plurality of processed speech signals based on the plurality of first signals.

11. The apparatus of claim 1, wherein the sound quality analyzer implements a non-intrusive auditory-articulatory analysis technique.

12. A method, comprising:
receiving at least one first signal indicative of at least one processed speech signal;
determining, non-intrusively, a sound quality of the at least one processed speech signal based on the at least one first signal; and
providing at least one second signal indicative of the sound quality of the at least one processed speech signal.

13. The method of claim 12, wherein receiving the at least one first signal comprises receiving the at least one first signal from a first interface configured to receive at least one processed speech signal and provide the at least one first signal based upon the at least one processed speech signal.

14. The method of claim 12, where providing the at least one second signal comprises:
providing the at least one second signal to a second interface configured to receive the at least one second signal; and
providing at least one third signal based upon the at least one second signal.

15. The method of claim 14, comprising providing the at least one third signal to a computer.

16. The method of claim 15, comprising displaying information indicative of the determined sound quality using a graphical user interface displayed on the computer.

17. The method of claim 16, wherein the step of displaying information indicative of the determined sound quality comprises:
displaying information indicative of at least one of:
a communication channel, the estimated sound quality, a time associated with the processed speech signal, and a duration of the processed speech signal.

18. The method of claim 12, comprising determining at least one modification to the processed speech signal based on the determined sound quality.

19. The method of claim 12, wherein non-intrusively determining the sound quality comprises determining the sound quality using a non-intrusive auditory-articulatory analysis technique.

20. The method of claim 19, wherein determining the sound quality using the non-intrusive auditory-articulatory analysis technique comprises comparing a power in an articulation frequency range of the processed speech signal and a power in a non-articulation frequency range of the processed speech signal.

21. The method of claim 12, wherein determining the sound quality comprises concurrently determining the sound quality of a plurality of processed speech signals.
